(19) United States
(12) Patent Application Publication
(10) Pub. No.: US 2005/0275770 A1
(43) Pub. Date: Dec. 15, 2005

(54) Liquid crystal display device and method of manufacturing the same

(75) Inventors: Tomohiro Kubota, Hyogo-ken (JP); Motoyuki Kitabata, Hyogo-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/148,209

(22) Filed: Jun. 9, 2005

(30) Foreign Application Priority Data
Jun. 10, 2004 (JP) 2004-173189

(51) Int. Cl. G02F 1/1333

(52) U.S. Cl. 349/110

(57) ABSTRACT

Counter substrate (color filter substrate) 2 is provided with light-shielding-layer pattern 22 to cover thin-film-transistors 13 in display region 5 and light-shielding-layer pattern 23 at edge portion out of display region to prevent light from leaking from display region 5. Inspection is not carried out to detect defects 21 of light-shielding-layer pattern 23 when counter substrate 2 is assembled, or done to detect them but counter substrate 2 is used in assembling a liquid crystal display device without repair. After defects 21 are detected and their positions are identified, laser light is irradiated to defects 21 on the condition that the liquid crystal display device is kept assembled. Such irradiation of the laser light disturbs alignment of alignment film 25 in portions corresponding to defects 21 in order to prevent the leakage of light from defects.

### CROSS-REFERENCE TO RELATED APPLICATION

This application is based upon and claims the benefit of priority from the prior Japanese Patent Application No. 2004-173189, filed on Jun. 10, 2004, the entire contents of which are incorporated herein by reference.

### FIELD OF THE INVENTION

This invention generally relates to a liquid crystal display device and a method of manufacturing the same.

### RELATED ART

Thin display devices, such as liquid crystal display devices, have been used for various applications as display devices for personal computers, word-processors and TV monitors and projection display devices. Active matrix type liquid crystal display devices, in particular, have pixels provided with thin-film-transistor (TFT) switching elements in a matrix form so that turned-on pixels are electrically isolated from turned-off pixels while video signals are held for a predetermined period of time by the tuned-on pixels. Since such active matrix type liquid crystal display devices achieve good image display without cross-talk between neighboring pixels, they have been widely used for various applications.

An active-matrix transmissive type liquid crystal display device will be briefly described by way of example. The active-matrix transmissive type liquid crystal display device has a TFT array substrate, a counter substrate provided opposite to TFT array substrate and a liquid crystal layer held between the TFT array and counter substrates. Circumferential portions of the TFT array and counter substrates are sealed to confine the liquid crystal layer by a sealing material.

The TFT array substrate includes an optically transparent and electrically insulated substrate, such as a glass substrate, on which parallel signal lines are disposed and pixel electrodes made from indium-tin-oxide (ITO) materials are arranged in a matrix form to make an image display region. Every pixel electrode is provided with a TFT switching element to connect the signal line with the pixel electrode. The switching elements are driven by scanning signals supplied through scanning lines. The scanning lines are disposed on the insulation substrate crossing with signal lines at about right angles.

The counter substrate also includes an optically transparent and electrically insulated substrate, such as a glass substrate, on which a counter electrode made from ITO materials is formed. The counter substrate or the TFT substrate has matrix-like light-shielding layers to optically shield the TFT switching elements and surroundings of the pixel electrodes. Further, a color filter layer is provided on the glass substrate for a color display. The color filter are composed of red (R), blue (B) and green (G) filters which are assigned to corresponding pixels.

The image display region may have bright points which are always bright due to defects of the switching elements or the like and affect image display quality. In order to rectify the defects, the pixels are prepared for repair circuits to disable and black them. In other words, the bright points are converted to black (turned-off) ones.

A variety of methods of turning off bright points by the irradiation of laser light have been proposed in Japanese Patent No. 3,224,942 and Japanese Unexamined Publication Nos. 10-133160 and 2001-133803. The methods are directed to a normally-white-mode active-matrix liquid crystal display device which normally displays bright pixel dots when no voltages are applied to their pixel electrodes. Laser light is irradiated to disturb liquid crystal alignments of defect points at an alignment film provided on the substrate. As a result, their polarization functions of the liquid crystal layer are lost, so that the normally-white-mode liquid crystal display device can reduce brightness at the defect dots.

As liquid crystal display devices become quickly and widely applicable to many applications, more improvements thereof are recently required for better image display performances with further reduction of production cost

The applicants of the present application have keenly studied various issues for the improvements and eventually focused on other regions than the image display region which were not regarded as display defects, if any, for repair. Some production processes have significant problems resulting from light beam transmission and reflection even in a region other than the image display regions.

Meanwhile, when light-shielding-layer patterns of liquid crystal display devices are made in a matrix form, other light-shielding-layer patterns are also provided for circumferential portions surrounding the image display region in the vicinity of the places where the sealing materials are injected. In such cases, there may be defects made in the light-shielding-layer pattern for the circumferential portions.

The light-shielding-layer pattern for the circumferential portions is provided to prevent light leakage from gaps defined between outer edges of the image display region and inner edges of a frame receiving the TFT and counter substrates. When such light leakage takes place, it may interfere with images displayed on the image display region and be offensive to the eye.

### SUMMARY OF THE INVENTION

Accordingly, the present invention provides a liquid crystal display device with improvements of image display performances and production-cost-reduction effects, and a method of manufacturing the same.

A major aspect of the present invention is directed to a liquid crystal display device provided with first and second insulation substrates, a liquid crystal layer held between the insulation substrates, scanning lines disposed on the first insulation substrate, signal lines disposed on the first or the second insulation substrate and crossed with the scanning lines at approximately right angles, and pixel electrodes arranged in vicinities of crossed points of the scanning and signal lines to form an image display region. Spacers are inserted in a gap between the first and second substrates while a sealing member combines the first and second substrates. Further, a light-shielding layer is provided at circumferential portions of the image display region and alignment films are coated on surfaces of the first and second substrate. One of the alignment films has alignment disturbed portions corresponding to the light-shielding-layer regions by irradiating laser light.

With the structure mentioned immediately above, where the light-shielding-layer pattern for the circumferential portions on the panel or the substrate has defects of leaking light, the defects can be repaired by the alignment disturbed portions, so that the panel or the substrate can be used as a quality item

The present invention provides a method of manufacturing a liquid crystal display device which carries out preparing first and second insulation substrates, and forming pixel electrodes on the first insulation substrate in a matrix as an image display region and substantially parallel signal lines on the first substrate. Scanning lines are then formed on the first or second insulation substrate crossing substantially with the signal lines. A light-shielding-layer pattern is provided on circumferential portions of the image display region. Alignment films are entirely coated on the pixel electrodes of the first insulation substrate and a surface of the second insulation substrate facing the pixel electrodes. The first and second insulation substrates are put together by a sealing material to define spaces where a liquid crystal material is injected. The light-shielding-layer pattern is inspected as for whether it has any defects in the alignment films. The liquid crystal display device can be repaired by the irradiation of laser light to disturb alignments of the alignment films substantially corresponding to points of such defects.

The laser light is preferably irradiated to repair the defects from the image display side.

The repair can be implemented without the dismantlement of any components even after a frame or a light source is assembled with the liquid crystal display device.

An output level of the laser light for the defect repair ranges from 0.5 mW (mJ/sec) to 1.2 mW (mJ/sec).

Thus, the defect repair can be sufficiently carried out by the disturbance of the alignments of the alignment film corresponding to the defects. Since the repair requires minimum energy, it does not cause a negative influence over layers or films adjacent to the defects even though the layers or films are more or less damaged by the laser light.

According to the present invention, a liquid crystal display device with improvements of image display performances and production-cost-reduction effects can be made available.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a schematically sectional and perspective view of a liquid crystal display device according to an embodiment of the present invention; and

FIG. 2 is a schematic plan view of the liquid crystal display device shown in FIG. 1.

### DESCRIPTION OF THE EMBODIMENT

Embodiments of the present invention will be explained below with reference to the attached drawings. It should be noted that the present invention is not limited to the embodiments but covers their equivalents. Throughout the attached drawings, similar or same reference numerals show similar, equivalent or same components.

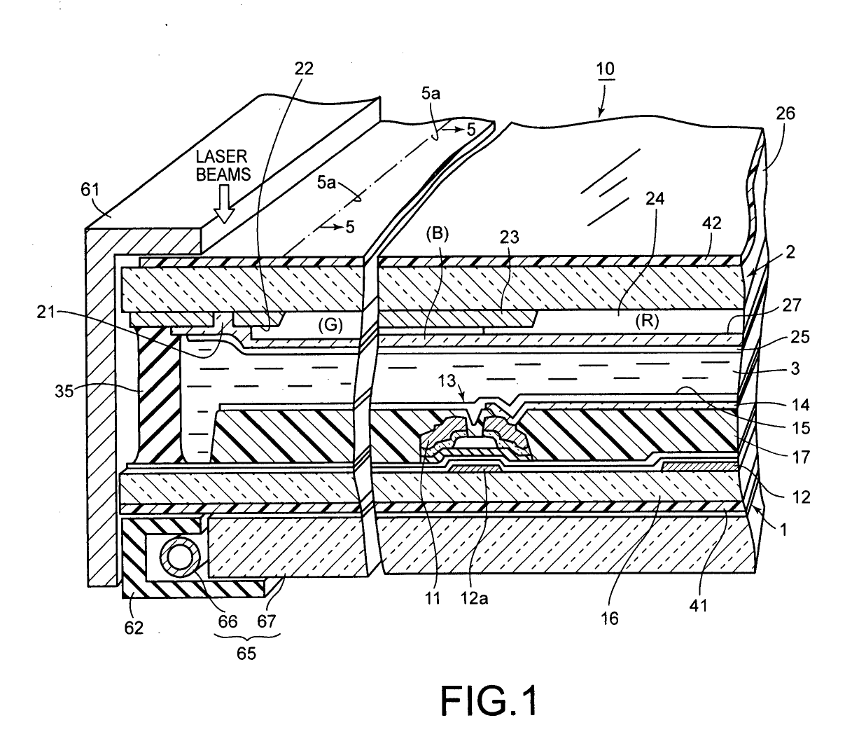

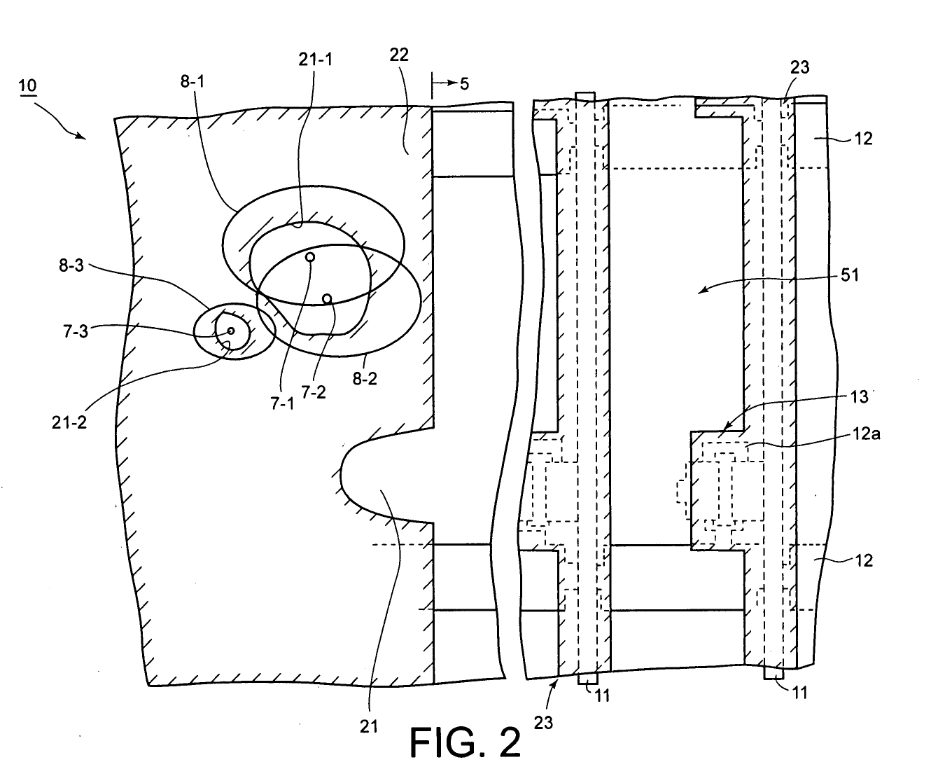

A normally-white-mode liquid crystal display device in accordance with a first embodiment of the present invention is described below with reference to FIGS. 1 and 2. FIG. 1 is a schematically sectional and perspective view of a liquid crystal display device to show its structure and repair of defects. FIG. 2 is a schematic plan view with partial defects of wiring and light-shielding-layer patterns in the liquid crystal display device shown in FIG. 1.

As shown in FIG. 1, display panel (liquid crystal cells) 10 of the liquid crystal display device is provided with TFT array and counter substrates 1 and 2 between which predetermined gaps are kept by spacers and a liquid crystal layer 3 is held. Seal material 35 is provided around circumferences of liquid crystal layer 3 to seal and join TFT array and counter substrates 1 and 2.

Liquid crystal layer 3 is made from a twisted nematic (TN) type liquid crystal material, for instance. Surfaces of TFT array and counter substrates 1 and 2 in contact with liquid crystal layer 3 are coated with alignment films 15 and 25 made from polyimide system resins.

As shown in FIGS. 1 and 2, TFT array substrate 1 is provided with signal and scanning lines 11 and 12 formed in a matrix on glass substrate 16 and thin-film-transistors 13 disposed in the vicinity of respective intersections of signal and scanning lines 11 and 12. Each square-like region defines pixel opening 51 surrounded by signal and scanning lines 11 and 12 and thin-film-transistor 13. Pixel opening 51 is covered with pixel electrode 14 made from a transparent and electrically conductive material, such as ITO. Thus, pixel electrodes 14 are arranged in a matrix to form display region 5.

In the embodiment shown in FIGS. 1 and 2, thick resin film 17 is formed between pixel electrodes 14 and a wiring layer.

Counter substrate 2 is provided with light-shielding-layer patterns 22 and 23, color filter 24 of red (R), green (G) and blue (B) layers assigned to corresponding pixel electrodes 14, and counter electrode 27 to cover light-shielding-layer patterns 22 and 23 and color filter 24, entirely. Counter electrode 27 is also made from a transparent and electrically conductive material, such as ITO. Light-shielding-layer patterns 22 and 23 are made from metal, such as chromium (Cr), or a resin layer containing black pigments or dyes.

A light-shielding layer in display region 5, i.e., light-shielding-layer pattern (black matrix) 23 covers thin-film-transistors 13 and the like. As shown in FIGS. 1 and 2, strip-like light-shielding-layer pattern 23 is formed to cover vicinities of thin-film-transistors 13 and signal lines 11. A method of repairing a liquid crystal display device according to the present invention is applicable to light-shielding-layer pattern 23 in display region 5, the configuration of which is grid-like (matrix) to cover additionally vicinities of scanning lines 12 or dispersion-point-like to cover only those of thin-film-transistors 13.

Light-shielding-layer pattern 22 is provided along edge portions 5a out of display region 5 on counter substrate 2. Light-shielding-layer patterns 22 and 23 are formed on a resin layer at the same time by a photolithography process or a ink-jet pattern drawing process.

The TFT array substrate and the counter substrate are manufactured by a method described in Japanese Patent Publication No. (Tokkai Hei) 8-160076, 2000-267595, 200-330484 or 2001-339070.

TFT array substrate 1 and counter substrate 2 are incorporated into display panel 10 in the following way. Polyimide system resin films are coated on pattern-forming surfaces of TFT array substrate 1 and counter substrate 2, respectively. The polyimide system resin films are then subjected to a rubbing treatment to form liquid crystal alignment films 15 and 25. Next, a sealing material is coated along edge portions of counter substrate 2 to make a pattern surrounding display region 5 entirely except a liquid crystal injection hole.

When TFT array substrate 1 and counter substrate 2 are put together, a rubbing angle of alignment films 15 on TFT array substrate 1 is set at 90° with respect to that of alignment films 25 on counter substrate 2. Subsequently, a liquid crystal material is injected into a gap defined by TFT array substrate 1 and counter substrate 2 through the injection hole, which is in turn closed with a sealing material.

Finally, polarizers 41 and 42 are put on the front and rear surfaces of display panel 10, i.e., the outer surfaces of TFT array substrate 1 and counter substrate 2. The absorption axel of polarizers 41 and 42 are set at 90° with each other and parallel with the rubbing directions of alignment films 15 and 25, respectively.

TFT array substrate 1 has a shelf portion which is extended from the edge portion incorporated with counter substrate 2 to connect driving circuits through flexible printed circuit boards. By way of example, tape carrier packages with driver integrated circuits mounted on flexible printed circuit boards by a tape automatic bonding (TAB) method are fixed on the shelf portion through anisotropically conductive films.

After the assembling of display panel 10, frames 61 and 62 are mounted on light source 65. As shown light source 65 is provided on the rear side of display panel 10 as a backlight unit. Tubular light source 66 and light guide 67 are received in resin frame 62. Display panel 10 is held between resin frame 62 and metal frame 61.

After the liquid crystal display device is assembled, a lighting inspection detects insufficiently bright points in the display region and a bright point due to defect 21 in the light-shielding layer at the edge portion.

When such bright points or defects are detected in the light-shielding layer at the edge portion, laser light is applied to repair the defects in the following way as the liquid crystal display device is kept assembled.

Defects 21 are measured for positions and approximate sizes.

When defect 21-2 is about 1 mm or less in diameter as shown in FIG. 2, irradiation spot 7-3 of laser light is roughly adjusted to coincide with the center of defect 21-2. A depth of focus of the laser light is preferably set to reach alignment film 25 on counter substrate 2.

It is desirable to use an energy (output) level of such irradiated laser light ranging from 0.5 mW to 1.2 mW (at a frequency of 1 kHz). Where the energy level of laser light is less than 0.5 mW, it is feared that the alignment film may be disturbed or an insufficient decline of brightness will occur in the defect. On the other hand, where the energy level of laser light is more than 1.2 mW, a sufficient decline of brightness or more is applied. Thus, it is also feared that wirings formed at the edge portions may be broken. As set forth above, the repair of defects at the edge portions can be conducted by applying an energy ray with less than the processing power required for the alignment films in the display region. As a result, the repair can be carried out without the cause of damage to the edge portions.

More concretely, according to an embodiment carried out by the applicants, Nd⁺³: YAG laser equipment has been used to irradiate a basic frequency (wavelength of 1.06 μm). Continuous oscillation laser light with an energy level of 1.0 mW (1 kHz) has been applied to the repair.

Further, the laser light has been irradiated for a proper period of time depending on positions and sizes of the defects.

As a result, a “vacuum bubble” which is larger in diameter than defect 21-2 has been generated to entirely cover defect 21-2. The “vacuum bubble” is a temporary bubble that is caused in liquid crystal layer 3 by irradiating laser light and completely disappears in a short time. It should be noted, however, that the vacuum bubble is different from a bubble caused by air mixed in liquid crystal layer 3. Alignment film 25 does not temporarily come into contact with the liquid crystal material in the region covered by the vacuum bubble so that thermal reaction and the like are added there. Thus, the state of alignment on alignment film 25 is well processed.

Such process for the state of alignment makes alignment film 25 lose its alignment function in relation to liquid crystal layer 3. Thus, it substantially prevents a normally-white-mode liquid crystal display device from the leakage of light.

Where defect 21-1 is about 2 mm in diameter or more, laser light is irradiated to each portion with a diameter of about 1 mm or less as shown in FIG. 2. In the example shown in FIG. 2, defect 21-1 is divided into two portions and irradiated laser spots 7-1 and 7-2 are focused on the central points of the two portions, respectively. At that time, vacuum bubbles 8-1 and 8-2 are caused by the irradiation of laser light, so that their edges reach over the edge of defect 21-1. In other words, defect 21-1 is entirely covered with the vacuum bubbles. Thus, even though defect 21-1 is relatively large in size, the minimum laser irradiation can process the entire region of interest in alignment film 25.

Defects may be those extended line-like. When counter substrate 2 is assembled, scratches may be made on light-shielding-layer pattern 22 at the edge portions. In order to repair them, laser light is sequentially irradiated to each portion with a diameter of about 1 mm or less as described above. An irradiating spot of laser light can be continuously moved along the scratches.

Defects may be cut-out portions from edge 5a of display region 5. In this case, however, the same repair process as for hole-like defects 21-1 and 21-2 are applied to the cut-out portions.

As set forth above, according to the embodiment of the present invention, the minimum repair process can easily and securely prevent light-leakage at edge portions of a liquid crystal display device. In particular, after assembling a liquid crystal display device, the detection and repair of defects 21 can be carried out by a simple manipulation. Thus, it is unnecessary to disassemble and reassemble the liquid crystal display device during the repair process. Further, since positions of defects 21 can be identified at their detection, it may be unnecessary to newly detect those of defects during the irradiation of laser light for the rep air.

Although the continuously oscillating laser light is used for the repair in the embodiment described above, pulsed laser light modulated with an ultrasound Q switch can also repair defects. Light-shielding-layer patterns are not always formed on the counter substrate as set forth above, but also formed on the TFT array substrate called the “black matrix on array” substrate. Even in the latter case, alignment film 25 on the side of counter substrate 2 may be processed by irradiating laser light from counter substrate 2 to defects of the light-shielding layer.

The embodiment is directed to the normally-white-mode liquid crystal display device by way of example but the present invention is also applicable a normally-black-mode liquid crystal display device.

The laser light is irradiated to alignment film 25 on counter substrate 2 in the embodiment described above but it can be irradiated to alignment film 15 on TFT array substrate 1. Since the laser light passes through liquid crystal layer 3 in the latter case that the laser light is irradiated from the display surface, the laser light is slightly higher in energy level than that of the former.

In the embodiment, the laser light is irradiated for the repair the defects after the liquid crystal display device is assembled. When defects 21 are detected before assembling the liquid crystal display device, the repair can be carried out for the display panel. In this case, even if the laser light is irradiated from the TFT array side, the number of processing steps does not increase but remains unchanged.

If defects 21 at the edge portion are detected before assembling the display panel, the laser light may be irradiated to disturb the alignment film of the defects 21 on counter substrate 2 at the time when the rubbing process is finished with respect to alignment film 25.

The laser light is not limited to Nd⁺³: YAG laser but Nd⁺³: YLF laser or even CO₂ laser or the like can be used. In the case of Nd⁺³: YAG laser or Nd⁺³: YLF laser, a basic, second or third harmonic wave can be also used.

The embodiment set forth above is directed to the optically-transmissive-type liquid crystal display device. The present invention is also applicable to reflective type, semi-transmissive type, thin-film-diode (metal-insulator-metal) switching type and passive matrix type liquid crystal display devices.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A liquid crystal display device comprising:
first and second insulation substrates having a display region and a circumferential region;
alignment films coated on the first and second insulation substrates;
a liquid crystal layer held between the alignment films on the insulation substrates;
a light-shielding-layer pattern provided on the first substrate; and
defects in the circumferential region of the light-shielding-layer pattern;
wherein alignment properties of the alignment films corresponding to the defects are disturbed.

2. A method of manufacturing a liquid crystal display device comprising:
preparing first and second insulation substrates;
coating first and second alignment films on the first and second insulation substrates, respectively;
placing the first alignment film opposite to the second alignment film to define a gap between the first and second alignment films;
injecting a liquid crystal into the gap:
forming a light-shielding-layer pattern at a circumferential region of the first insulation film
inspecting the light-shielding-layer pattern as to whether the light-shielding-layer pattern has any defects; and
irradiating laser light to disturb an alignment property of portions of the alignment film corresponding to the defects.

3. A method of manufacturing a liquid crystal display device according to claim 2, wherein the laser light is irradiated from a display surface side of the liquid crystal display device.

4. A method of manufacturing a liquid crystal display device according to claim 2 or 3, wherein an output power of the laser light ranges from 0.5 mW to 1.2 mW.

5. A method of manufacturing a liquid crystal display device according to claim 4, wherein the laser light is irradiated to each center portion of the defects when each of the defects is 1 mm in diameter or less and to each portion per 1 mm diameter of the defects when each of the defects is more than 1 mm in diameter.
